(19) United States
(12) Patent Application Publication
(10) Pub. No.: US 2008/0262930 A1
(43) Pub. Date: Oct. 23, 2008

(54) Advertising on Labels of Medicine Containers

(75) Inventors: David A. Miceli, Sparta, TN (US); Joseph A. Miceli, Sparta, TN (US)

Correspondence Address: WADDEY & PATTERSON, P.C., 1600 DIVISION STREET, SUITE 500, NASHVILLE, TN, 37203, US

(73) Assignee: TRI STATE DISTRIBUTION, INC, Sparta, TN (US)

(21) Appl. No.: 12/106,431

(22) Filed: Apr. 21, 2008

Related U.S. Application Data
(60) Provisional application No. 60/912,721, filed on Apr. 19, 2007.
(60) Provisional application No. 60/943,600, filed on Jun. 13, 2007.

(51) Int. Cl. G06Q 30/00

(52) U.S. Cl. 705/14

(57) ABSTRACT

The present invention is directed to an advertisement positioned on a pharmaceutical container that does not substantially interfere with the medical information positioned on the pharmaceutical container.

### CROSS-REFERENCES TO RELATED APPLICATIONS

This application is a non-Provisional application which claims benefit of co-pending U.S. Patent Application Ser. No. 60/912,721 filed Apr. 19, 2007, entitled “Advertising on Labels of Medicine Containers” and this application is a non-Provisional application which claims benefit of co-pending U.S. Patent Application Ser. No. 60/943,600 filed Jun. 13, 2007, entitled “Advertising on Labels of Medicine Containers”, both of which are hereby incorporated by reference in their entireties.

A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

All patents and publications described or discussed herein are hereby incorporated by reference in their entireties.

### BACKGROUND OF THE INVENTION

The present invention relates generally to advertisements used in conjunction with a vial, bottle, or other container and a closure, which may be described as a cap or a top. The combination of the container and closure can be described as a closure container assembly or system. The closure and container assembly stores and dispenses materials, particularly pharmaceuticals. The advertisement is positioned on the container in such a manner as to relay information concerning the goods advertised to the person that uses the container enclosure system.

There are many types of closure systems described in the art. For example there are closures that are child resistant, closures that are non child resistant, and closures that are convertible from child resistant to non child resistant, from non child resistant to child resistant, or convertible between the two modes multiple times.

Most of the prior development in this field has been directed at improvements to the containers and/or closures that are used to store pharmaceuticals. Very little advancement has been directed towards the labeling or information provided with the pharmaceuticals or the labeling attached to the container.

Another factor in today's global economy is the desire for product and service providers to capture the attention of consumers and potential consumers to entice those consumers to buy and/or use their products or services. There is a logical consistency to the use of advertising media or avenues that will put the advertisement in front of the consumers that are more likely to use those goods or services. For example, advertisements for children's toys have a logical placement during the broadcast of children's shows, such as cartoons, to attract the interest of the children in those particular toys. Correspondingly, products that are directed specifically to persons interested in sports, such as sports equipment, logically have a placement during the broadcast of sporting events or in sporting magazines.

Up until this point the space on a pharmaceutical container, namely the label or labels positioned thereon, have been used to provide information concerning the pharmaceuticals contained therein including the dosage warnings and other pertinent information. As such, there is a medium there to provide advertisements to the captive audience that has requested and received the container and the associated labeling thereon.

In light of the foregoing there is a need for advertisements positioned on a pharmaceutical container. The advertisements preferably do not interfere with the medical information positioned on the pharmaceutical container such that a reader of that information and the advertisement can readily read, ascertain and comprehend the medical information and the advertisement.

### BRIEF SUMMARY OF THE INVENTION

The present invention is directed to advertisements adapted for use in a closure and container system that can substantially obviate one or more of the problems due to limitation and disadvantage of the related art. Additional features and advantages of the invention will be set forth in the description which follows, and in part will be apparent from the description, or may be learned by practice of the invention. The objects and other advantages of the invention can be further realized and attained by those features of the invention particularly pointed out in the description and claims hereof as well as the appended drawings.

The present invention is directed to an advertisement positioned on a pharmaceutical container, and preferably to a prescription container, that does not substantially interfere with the medical information positioned on the pharmaceutical container.

The advertisement is used in connection with a pharmaceutical storing and dispensing device having a closure and container. The pharmaceutical storing and dispensing device includes a label having alphanumeric indicia containing the medical information. These alphanumeric indicia can be orientated on the label in multiple manners, such as substantially parallel or perpendicular with the axis of the container. The label can include the patient's name, name of the medicine, and optionally other medical information concerning the pharmaceutical within the container or the user of the container.

The advertisement can be any advertisement, but preferably is directed at medical goods or services or goods or services that are geographically specific to the user and/or patient using the pharmaceutical storing and dispensing device or the location of the purchase of the pharmaceutical storing and dispensing device.

The container includes a bottom and a neck having an opening and one or more engaging devices positioned and shaped to interact with corresponding engaging devices on the closure. The axis of the container runs through the opening and bottom of the container.

The label and advertisement can include widths that span substantially from the bottom to the neck of the container. The indicia positioned on the label and/or advertisement can also substantially traverse these widths. This provides an opportunity for an advertiser to directly target specified customer for a focused marketing effort.

The advertisement can be included as part of the label that has the medical information, can be attached directly to the label after the label has been made (either before or after the attachment of the label to the container), or can be independently attached to the container.

It is therefore a general object of the present invention to provide advertisements on pharmaceutical containers.

Another object of the present invention is to provide advertisements on the labeling of pharmaceutical containers.

Still another object of the present invention is to provide advertisements on a pharmaceutical container such that the advertisements do not interfere with the medical or user information positioned on the container.

Other and further objects, features and advantages of the present invention will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 shows a pharmaceutical system made in accordance with the current disclosure having medical information labeling and an advertisement.

FIG. 2 shows an alternate embodiment of a pharmaceutical system made in accordance with the current disclosure having medical information labeling and an advertisement.

FIG. 3 is a bottom view of the embodiment shown in FIG. 2.

FIG. 4 is a side view of labeling and an advertisement on alternate pharmaceutical storage system.

FIG. 5 is a perspective view of FIG. 4.

FIG. 6 is a perspective view of labeling and an advertisement shown on a container having multiple sides and made in accordance with the current disclosure.

FIG. 7 is a top view of the container shown in FIG. 6.

FIG. 8 is a top view of labeling and an advertisement shown on an alternate container having multiple sides and made in accordance with the current disclosure.

### DETAILED DESCRIPTION OF THE INVENTION

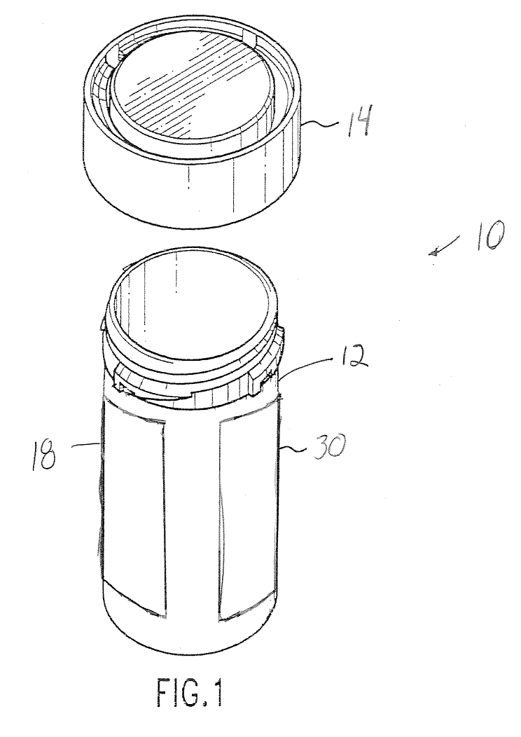

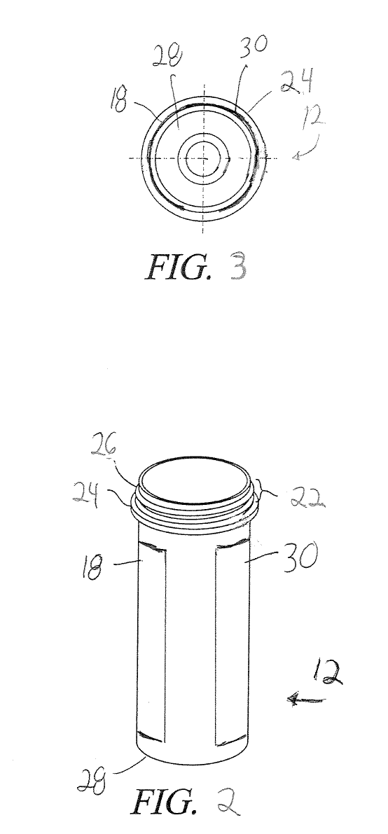

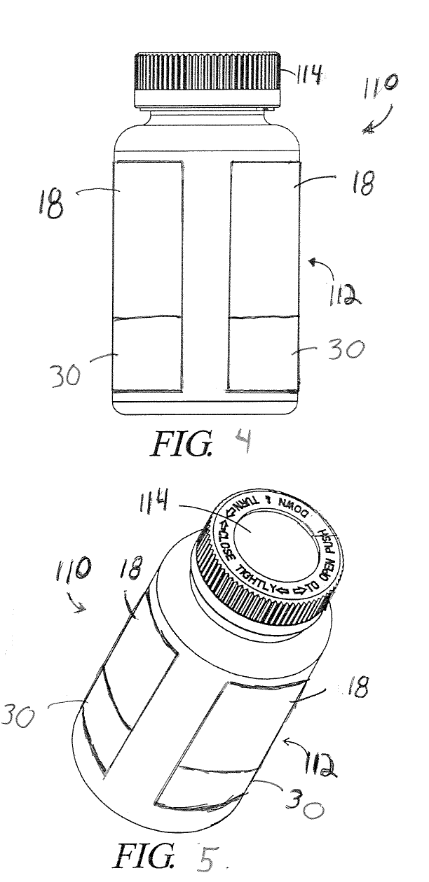

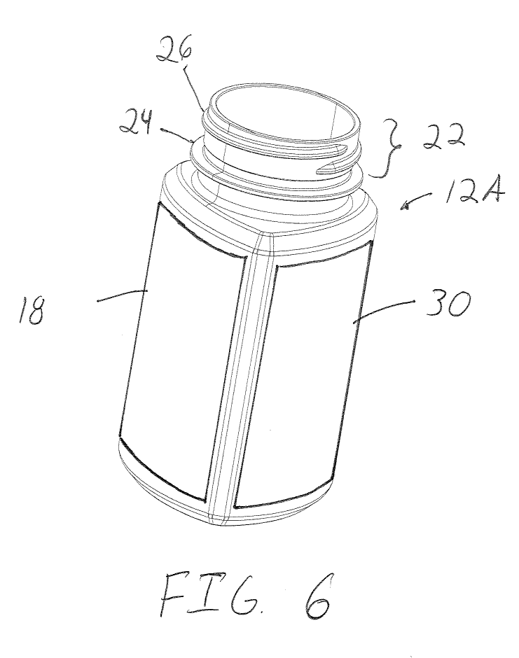

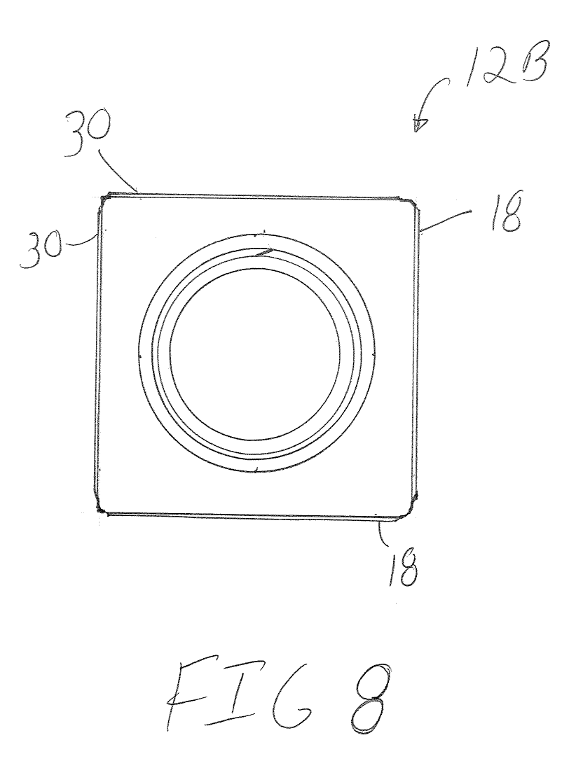

As shown in FIGS. 1-8, the current invention includes at least one advertisement 30 positioned on a pharmaceutical container 12 that is used for storage and dispensing of pharmaceuticals. The pharmaceutical container 12 includes a closure 14 to facilitate the storage of the pharmaceuticals.

The container 12 includes a neck 22 having a rim 24, or neck 24, and an engaging device 26. The engaging device 26 contacts the closure 14 to secure the closure 14 to the container 12. The engaging device 26 is designed to interact with an engaging mechanism on the closure 14 to secure the pharmaceuticals contained on the inside of the container 12. Suitable engaging devices or engaging mechanism can include one or more beads, threads, lugs or the like as is known in the art.

The bottom 28 of the container 12 and rim 24 typically provide enough space to position the label 18 there between. The label 18 can include a length that substantially spans the distance between the neck 22 and bottom 28.

The pharmaceutical system 10 generally comprises a label 18 having traditional medical information such as the patient name, pharmaceuticals, dosage, warnings, and other typical prescription label information. In accordance with the current invention, the pharmaceutical system 10 includes the advertisement 30 preferably separated from the label 18. Alternately, the advertisement 30 can be included as a section, or part, of the label 18 before the label is affixed to the container 12. For example, the advertisement 30 can be printed on the same substrate as the label 18. Additionally, the advertisement 30 can be positioned over a portion of the label 18 after the label is affixed to the container 12. The advertisement 30 and/or label 18 can, independently or collectively, substantially span the distance between the rim 24 and bottom 28 of the container 12.

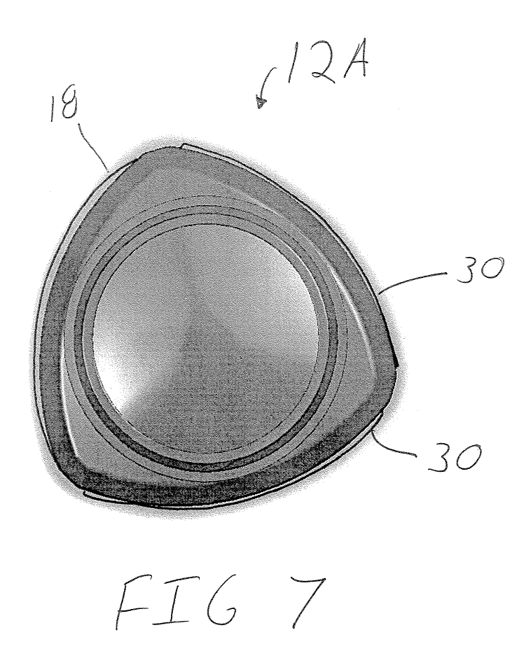

Additionally, depending on the primary configuration of the container 12, multiple labels 18 or advertisements 30 can be positioned on various portions or sides of the container 12. This is best illustrated in FIGS. 6-8. For example, the container can take various shapes, such as circular which is known and typically used in the art, or can be designed to be triangular, quadrilateral and the like.

The advertisement can be specifically directed goods or services that are medically related to the pharmaceutical in the container. The advertisement can be specifically directed at items that the user may associate with the pharmaceuticals dispensed in the pharmaceutical storage system 10. For example, advertisements directed at diabetic testing equipment can be positioned on a pharmaceutical container that carries a prescription of diabetic medicine therein. As such the advertisements can be user specific.

Alternately, the advertisements can be general to a specific location such as local businesses within a predetermined distance of the pharmacy or group of pharmacies where the pharmaceutical storage system 10 was purchased. Specific items can be advertised, such as specials for particular business, such as the pharmacy where the pharmaceutical storage system 10 was purchased. Additionally, coupons, such as removable coupons, can be added to the advertising sections. These coupons can be added to any portion of the labels 18 or advertisements 30—such as the top bottom or sides. In a preferred embodiment, the coupon can be attached to the advertisement 30 or label 18 and extend from the surface of the container 12 such that the coupon is not fixed to the container 12. For example, the coupon can have a first side extending from the label 12 or advertisement 30 and a second side spaced from the perimeter of the container 12 that is not adhered to the container 12. This facilitates removal and subsequent use of the coupon. Alternately, the coupon can be removably fixed to the container 12, such as by light adhesive and he like, so that a user can peel the coupon from the container for subsequent use. Additionally, the advertisement 30 can be the coupon itself and can be removable from the container 12. For example, the advertisement/coupon can include a perforated type attachment to the label 18 on a first side. The advertisement/coupon could then be adhered to the container 12 or spaced from the container 12.

In operation, a central processing unit, such as a computer, can be linked to a database of available advertisements. Once the operator, for example a pharmacist selects the pharmaceutical that will be positioned in the container and is ready to print the associated label for the same, the computer can selected an advertisement that corresponds to either 1) the user/patient specifically, 2) the pharmaceutical that will be or is already positioned in the container, 3) location specific criteria, such as items and services sold at the location—e.g. store specials. The advertisement can be printed as part of the label or independently therewith for placement on the container with or subsequent to the positioning of the label on the container.

Thus, although there have been described particular embodiments of the present invention of a new and useful Advertising on Labels of Medicine Containers, it is not intended that such references be construed as limitations upon the scope of this invention except as set forth in the following claims.

What is claimed is:

1. A pharmaceutical container system for holding and dispensing a pharmaceutical to a user of the pharmaceutical container system, the pharmaceutical container system comprising:
a container shaped to hold a pharmaceutical and including a perimeter;
a closure shaped to engage the container and form a seal with the container to secure the pharmaceutical;
a label positioned on the perimeter of the pharmaceutical and including indicia having the user's name, the name of the pharmaceutical contained in the container, and optionally other medical information; and
an advertisement positioned on the perimeter of the pharmaceutical container.

2. The pharmaceutical container system of claim 1 wherein the advertisement and label are spaced around the perimeter of the container.

3. The pharmaceutical container system of claim 1 wherein the advertisement and label are printed on separate substrates.

4. The pharmaceutical container system of claim 3 wherein the advertisement and label are independently positioned on the container.

5. The pharmaceutical container system of claim 4 wherein the advertisement and label are spatially separated on the container.

6. The pharmaceutical container system of claim 1 wherein the advertisement and label are printed on the same substrate.

7. The pharmaceutical container system of claim 1 wherein the advertisement is directed at an item that is geographically specific to the user of the pharmaceutical container system.

8. The pharmaceutical container system of claim 1 wherein the advertisement is directed at a service that is geographically specific to the user of the pharmaceutical container system.

9. The pharmaceutical container system of claim 1 wherein the advertisement is directed at an item that is offered for sale at the location of the purchase of the pharmaceutical container system.

10. The pharmaceutical container system of claim 1 wherein the advertisement is directed at a service that are offered for sale at the location of the purchase of the pharmaceutical container system.

11. The pharmaceutical container system of claim 1, wherein container further includes a neck separated a distance from a bottom and the label substantially spans the distance between the neck and bottom and the circumference of the container.

12. The pharmaceutical container system of claim 1 further including a coupon attached to the label and spaced from the perimeter of the container.

13. The pharmaceutical container system of claim 1 wherein the advertisement is a coupon having a first side extending from the label and a second side spaced from the perimeter of the container.

14. A pharmaceutical container system for holding and dispensing a pharmaceutical to a user of the pharmaceutical container system, the pharmaceutical container system comprising:
a container shaped to hold a pharmaceutical and including a longitudinal axis, a perimeter, a neck, a bottom, an open end, and a container engaging device;
a closure including an engaging mechanism designed to engage the container engaging device to close the open end and form a seal with the container to secure the pharmaceutical
a label positioned on the perimeter of the pharmaceutical and including indicia having the user's name, the name of the pharmaceutical contained in the container, and optionally other medical information; and
an advertisement positioned on the perimeter of the pharmaceutical container.

15. The pharmaceutical container system of claim 14 wherein the advertisement and label are printed on separate substrates.

16. The pharmaceutical container system of claim 15 wherein the advertisement and label are independently positioned on the container.

17. The pharmaceutical container system of claim 16 wherein the advertisement and label are spatially separated on the container.

18. The pharmaceutical container system of claim 14 wherein the advertisement and label are printed on the same substrate.

19. The pharmaceutical container system of claim 14 wherein the advertisement is directed at an item or service that is medically related to the pharmaceutical in the container.

20. The pharmaceutical container system of claim 14 wherein the advertisement is directed at an item or service that is geographically specific to the user of the pharmaceutical container system.

21. The pharmaceutical container system of claim 14 wherein the advertisement is directed at an item or service that is offered for sale at the location of the purchase of the pharmaceutical container system.

22. The pharmaceutical container system of claim 14 further including a coupon attached to the label and spaced from the perimeter of the container.

23. The pharmaceutical container system of claim 14 wherein the advertisement is a coupon having a first side extending from the label and a second side spaced from the perimeter of the container.

24. A pharmaceutical container system for holding and dispensing a pharmaceutical to a user of the pharmaceutical container system, the pharmaceutical container system comprising:
a container shaped to hold a pharmaceutical and including a longitudinal axis, a perimeter, a neck, a bottom, an open end, and a container engaging device;
a closure including an engaging mechanism designed to engage the container engaging device to close the open end and form a seal with the container to secure the pharmaceutical
a label positioned on the perimeter of the pharmaceutical and including indicia having the user's name, the name of the pharmaceutical contained in the container, and optionally other medical information; and
an advertisement positioned on the perimeter of the pharmaceutical container, the advertisement selected from the group consisting of an advertisement corresponding to either the user, the pharmaceutical, or geographical specific criteria.
